(19) United States
(12) Patent Application Publication
(10) Pub. No.: US 2005/0068978 A1
(43) Pub. Date: Mar. 31, 2005

(54) High performance network communication device and method

(75) Inventors: Daniel White Sexton, Niskayuna, NY (US); Scott Charles Evans, Burnt Hills, NY (US); Marc Robert Pearlman, Clifton Park, NY (US)

Correspondence Address: Jean Testa, Esq.;GE Global Research Center, P.O. Box 8, Schenectady, NY, 12301, US

(73) Assignee: General Electric Company

(21) Appl. No.: 10/672,043

(22) Filed: Sep. 26, 2003

(51) Int. Cl. H04L 12/413

(52) U.S. Cl. 370/445

(57) ABSTRACT

A network communication device for bi-directional communication networks is provided having a first portion and a second portion. The first portion is connectable to a first point and a second point on the bi-directional communication network. Similarly, the second portion is connectable to the first and second points. The first portion manages collisions among a first set of messages transmittable from the first point to the second point. However, the second portion transmits free of collision management a second set of messages transmittable from the second point to the first point.

### BACKGROUND OF THE INVENTION

The present disclosure relates generally to network communication devices. More particularly, the present disclosure relates to a high performance network communication device and method.

Data networks communicate data among the various points on the network. Such data networks typically require one or more network communication devices, such as network hubs and network switches. Each of these devices can have beneficial or detrimental effects on the communication across the network.

For example, network hubs provide the ability to communicate multiple messages with a minimal latency through the hub. However, messages received by the network hub can collide in the hub and cause data transmission errors. Conversely, network switches manage the collisions created by multiple messages. However, these switches typically add latency to the network due to the collision management.

Accordingly, there is a continuing need for a network communication device that mitigates and/or eliminates one or more of the aforementioned and other drawbacks and deficiencies of prior communication devices.

### BRIEF DESCRIPTION OF THE INVENTION

A network communication device for bi-directional communication networks is provided. The device includes a first portion and a second portion. The first portion is connectable to a first point and a second point on the bi-directional communication network. Similarly, the second portion is connectable to the first and second points. The first portion manages collisions among a first set of messages transmittable from the first point to the second point. However, the second portion transmits free of collision management a second set of messages transmittable from the second point to the first point.

A bi-directional communication device having a hub portion, a switch portion, a first plurality of connections, and a second plurality of connections is provided. The first plurality of connections connect the hub portion to a plurality of first points on the bi-directional communication network and to a second point on the bi-directional communication network. The second plurality of connections connect the switch portion to the plurality of first points and to the second point.

A method of communicating messages on a bi-directional communication network is also provided. The method includes transmitting a first message from each of a plurality of first points on the bi-directional communication network to a single second point on the bi-directional communication network through a switch portion of a communication device; and transmitting a second message from said single second point to said plurality of first points through a hub portion of said communication device.

The above-described and other features and advantages of the present disclosure will be appreciated and understood by those skilled in the art from the following detailed description, drawings, and appended claims.

### BRIEF DESCRIPTION OF THE DRAWINGS

FIG. 1 illustrates an exemplary embodiment of a high performance network communication device in use with a power distribution system;

FIG. 2 is a schematic of a first exemplary embodiment of the high performance network communication device of FIG. 1;

FIG. 3 is a schematic of a second exemplary embodiment of the high performance network communication device of FIG. 1; and

FIG. 4 is a schematic of a third exemplary embodiment of the high performance network communication device of FIG. 1.

### DETAILED DESCRIPTION

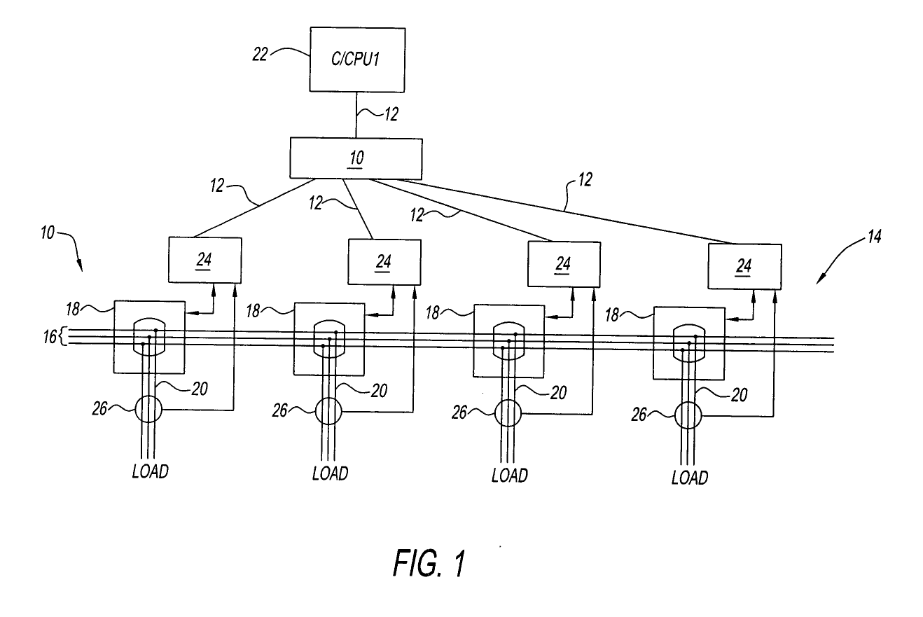

Referring now to the drawings and in particular to FIG. 1, an exemplary embodiment of a high performance network communication device generally referred to by reference numeral 10 is illustrated. Device 10 is configured to facilitate communication across a data network 12. For example, device 10 and network 12 can be configured to communicate electrical messages, optical messages, acoustic messages, and any combinations thereof.

For purposes of clarity, device 10 is illustrated in use with a centrally controlled power distribution system 14. System 14 distributes power from at least one power bus 16 through a number or plurality of circuit breakers 18 to branch circuits 20. Each circuit breaker 18 has a set of separable contacts (not shown) that selectively place power bus 16 in electrical communication with at least one load on circuit 20. The load can include devices, such as, but not limited to, motors, welding machinery, computers, heaters, lighting, and/or other electrical equipment.

System 14 is configured to distribute, control and monitor the power within the system via a central control processing unit 22 (hereinafter “CCPU”) and a number or plurality of data sample and transmission modules 24 (hereinafter “module”). CCPU 22 communicates with modules 24 over data network 12 and through device 10. The communication speed of device 10 can be an important component of the operation of the system. Specifically, in order for system 14 to control and monitor the power within the system, the communication between CCPU 22 and modules 24 should have a minimal latency.

In the illustrated embodiment, modules 24 receive/collect data related to a condition of the power in bus 16 from sensors 26. Sensors 26 can include current transformers (CTs), potential transformers (PTs), and any combination thereof. Sensors 26 monitor a condition of power in circuits 20 and provide data representative of the condition of the power to module 24. In operation, each module 24 simultaneously communicates the data from modules 24 to CCPU 22 over network 12. In response to the data from modules 24, CCPU 22 sends a broadcast message back to all of the modules to control its respective breaker 18, as required.

Centralized protection and control as in system 14 requires reliable, low latency, high bandwidth, synchronized message delivery. While current Ethernet is capable of meeting these performance requirements, the available communication devices (e.g., hubs and switches) are typically not capable of meeting all these requirements. However, it has been determined that the desired minimal latency required by system 14 can be achieve by device 10, which is configured to handle some messages using a switch portion, while handling other messages using a hub function.

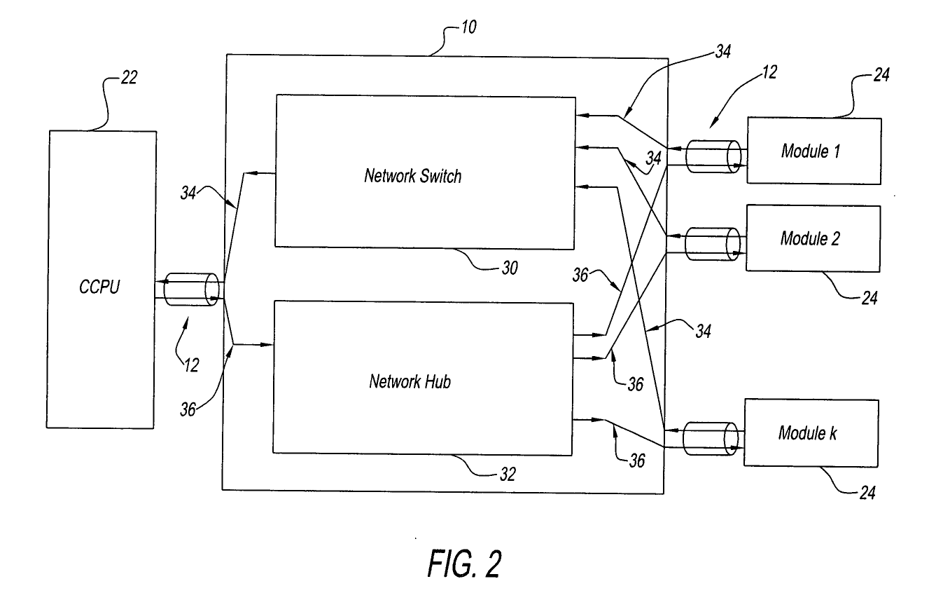

A first exemplary embodiment of device 10 is described with reference to FIG. 2. Device 10 includes a switch portion 30 and a hub portion 32 integrated to function together to transmit messages across network 12. In the illustrated embodiment, switch and hub portions 30, 32 are illustrated as separate digital devices. However, it is contemplated by the present disclosure for switch and hub portions 30, 32 to reside in a single digital device.

The simultaneous messages from modules 24 to CCPU 22, namely upward messages 34, can collide as they are transmitted through device 10. By arranging the message from CCPU 22 from modules 24 as a single broadcast message, namely downward message 36, the downward message does not have an issue with collisions.

Device 10 is configured to transmit upward messages 34 through switch portion 30 to manage collisions. The management of upward messages 34 by switch portion 30 adds some latency to the speed with which the upward messages travel through device 10. Conversely, device 10 is configured to transmit downward message 36 through hub portion 32, which transmits the downward messages with minimal latency.

Device 10 isolates upward messages 34 from downward messages 36 by relaying the upward messages through switch portion 30, while relaying the downward messages through hub portion 32. Switch portion 30 ensures collision free access for upward messages 34. Further, hub portion 32 transmits downward messages 36, without compromising collision-free channel access, since the single data source (e.g., CCPU 22) guarantees that the channel is always contention free, reducing the overall system latency and cost. It has also been found that isolation of the upward and downward messages 34, 36 permits full duplex communication through network 12. It has also been found that the network adapters (not shown) in CCPU 22 and modules 24 must operate in a mode where collision detection, if any, is disabled in order to achieve the aforementioned full duplex operation.

As such, device 10 provides low latency, simultaneous data distribution for the contention-free downward messages 36 via hub portion 32. However, contention-free communication (e.g., upward messages 34) to a common point (e.g., CCPU 22) is controlled through switch portion 30.

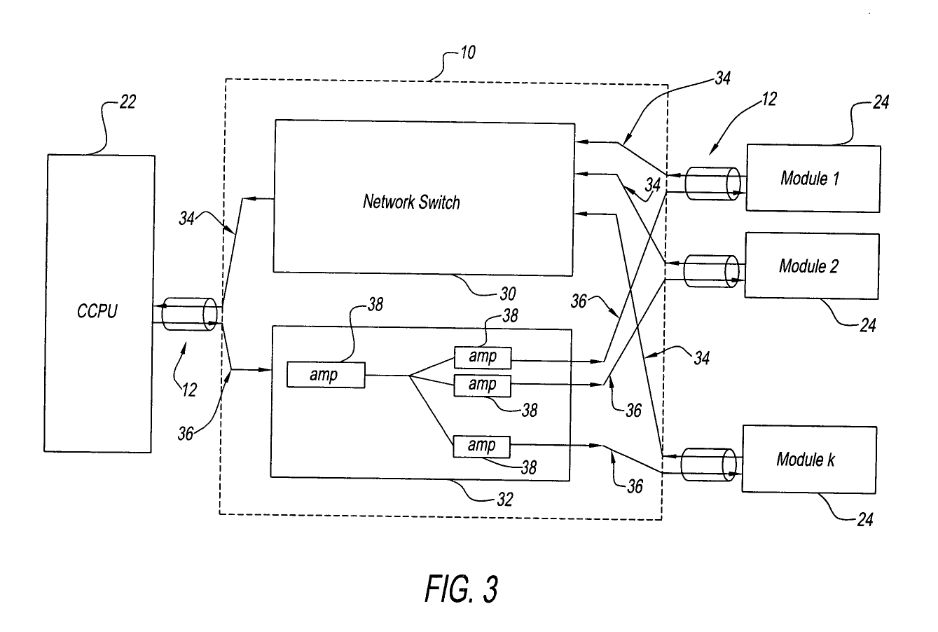

A second exemplary embodiment of device 10 is described with reference to FIG. 3. Here, switch portion 30 is illustrated as a digital switch, while hub portion 32 is illustrated as an analog hub. Specifically, hub portion 32 can include a number or plurality of amplifiers 38.

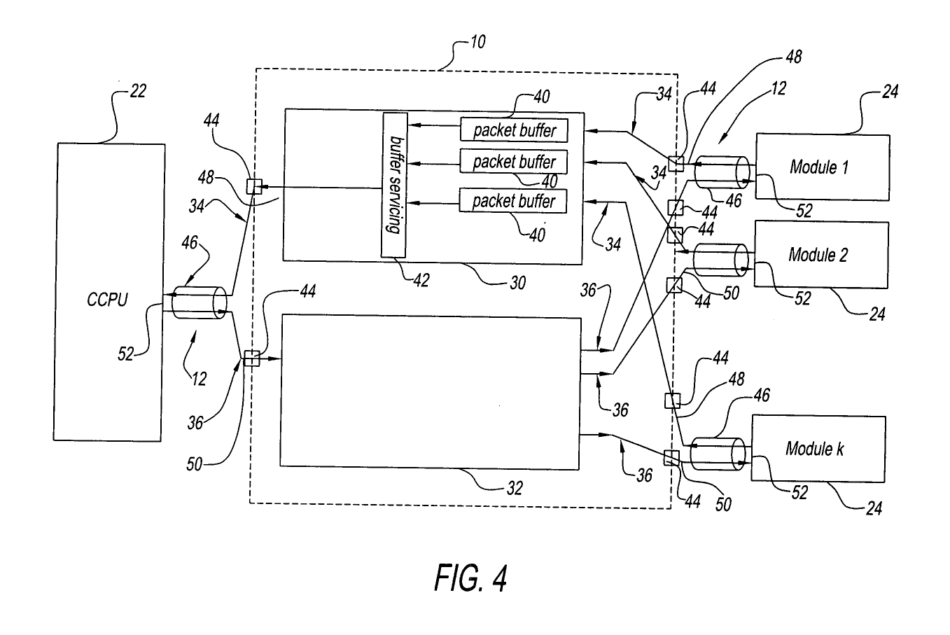

A third exemplary embodiment of device 10 is described with reference to FIG. 4. Here, switch portion 30 is illustrated as an analog switch, while hub portion 32 is illustrated as a digital hub. Specifically, switch portion 30 is illustrated as a static switch having a number or plurality of amplifiers packer buffers 40 in electrical communication with a buffering circuit 42.

In the exemplary embodiments of FIGS. 3 and 4, switch and hub portions 30, 32 are illustrated as separate analog and digital devices. However, it is contemplated by the present disclosure for switch and hub portions 30, 32 to reside in a single combined analog digital device. Moreover, it is contemplated for both switch and hub portions 30, 32 to be separate or combined analog devices.

In the embodiment illustrated in FIG. 4, device 10 has eight connection points 44. Here, connection points 44 can be, for example, standardized or off the shelf Ethernet cable connections to allow device 10 to be easily integrated into network 12. Thus, the interconnection of network 12 to device 10 can be made by way of standardized or off-the-shelf Ethernet cable connections.

Advantageously, device 10 is configured to route the upward and downward messages 34, 36 in a manner that takes into account the need for both collision management and minimal latency. Specifically, device 10 is a bi-directional network communication device that transmits messages in a first direction in a first manner, but transmits messages in a second direction in a second manner.

In another embodiment of the present disclosure also illustrated in FIG. 4, device 10 can be connected to network 12 by way of a bifurcated cable 46. Here, bifurcated cable 46 can be configured to route the upward and downward messages 34, 36 into and out of device 10. For example, bifurcated cable 46 can include a first end 48, a second end 50, and a third or combined end 52. Bifurcated cable 46 is configured to transmit upward messages 34 between first and third ends 48, 52. In addition, bifurcated cable 46 is configured to transmit downward messages 36 between second and third ends 50, 52. Thus, third end 52 of bifurcated cable 46 is standard, while the other end (e.g., first and second ends 48, 50) is split. In this manner, cable 46 routes messages to and from device 10 so that the device can provide the aforementioned collision management and minimal latency.

In all embodiments, , device 10 provides improved performance (reduced latency and jitter, greater data capacity, tighter inter-port synchronization, etc.) at a lower cost as compared with existing general purpose switch and hub technologies by focusing on the specific characteristics of the upward and downward messages 34, 36. Furthermore, device 10 interfaces with present Ethernet endpoint adapters and/or cables, and retains the ability to provide performance/cost improvements through the integration of Ethernet hubs and switches.

It should be recognized that device 10 is illustrated herein by way of example in use with centrally controlled power distribution system 14. Of course, it is contemplated by the present disclosure for device 10 to find use with other “one-to-many” bi-directional communication architectures.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the instant disclosure has been described with reference to one or more exemplary embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this invention, but that the invention will include all embodiments falling within the scope of the appended claims.

1. A network communication device for bi-directional communication networks, comprising:
a first portion connectable to a first point and a second point on the bi-directional communication network, said first portion being configured to manage collisions among a first set of messages transmittable from said first point to said second point; and
a second portion connectable to said first point and said second point, said second portion being configured to transmit free of collision management a second set of messages transmittable from said second point to said first point.

2. The network communication device as in claim 1, wherein said first and second messages are selected from the group consisting of electrical messages, optical messages, acoustic messages, and any combinations thereof.

3. The network communication device as in claim 1, wherein said first portion is a network switch.

4. The network communication device as in claim 3, wherein said network switch is an analog switch or a digital switch.

5. The network communication device as in claim 1, wherein said second portion is a network hub.

6. The network communication device as in claim 5, wherein said network hub is an analog hub or a digital hub.

7. The network communication device as in claim 1, wherein said first and second portions are separate devices or a single device.

8. The network communication device as in claim 1, further comprising a plurality of network connections for connecting said first and second portions to said first and second points.

9. The network communication device as in claim 8, wherein said plurality of network connections are standardized Ethernet cable connections.

10. A bi-directional communication device comprising:
a hub portion;
a switch portion;
a first plurality of connections for connecting said hub portion to a plurality of first points on a bi-directional communication network and to a second point on the bi-directional communication network; and
a second plurality of connections for connecting said switch portion to said plurality of first points and to said second point.

11. The bi-directional communication device as in claim 10, wherein said hub portion is configured to transmit first messages from said second point to said plurality of first points.

12. The bi-directional communication device as in claim 11, wherein said hub portion is configured to transmit said first messages without collision management.

13. The bi-directional communication device as in claim 10, wherein said switch portion is configured to transmit second messages from said plurality of first points to said second point.

14. The bi-directional communication device as in claim 13, wherein said switch portion is configured to manage collisions among said second messages.

15. The bi-directional communication device as in claim 10, wherein said network switch and said network hub are analog devices, digital devices, or any combination thereof.

16. The bi-directional communication device as in claim 15, wherein said hub and switch portions are separate devices or a single device.

17. The bi-directional communication device as in claim 10, wherein said first and second plurality of connections are standardized Ethernet cable connections.

18. A method of communicating messages on a bi-directional communication network, comprising:
transmitting a first message from each of a plurality of first points on the bi-directional communication network to a single second point on the bi-directional communication network through a switch portion of a communication device; and
transmitting a second message from said single second point to said plurality of first points through a hub portion of said communication device.

19. The method as in claim 18, wherein said switch and hub portions are analog devices, digital devices, or any combinations thereof.

20. The method as in claim 19, wherein said switch and hub portions are separate devices or a unitary device.
